(19) United States
(12) Patent Application Publication
(10) Pub. No.: US 2026/0312693 A1
(43) Pub. Date: Oct. 8, 2026

(54) SEGMENTED RECEIVER FOR PHASE-MODULATED SIGNALS

(71) Applicant: Raytheon Company, Arlington, VA (US)

(72) Inventors: Benjamin P. Dolgin, Aventura, FL (US); Andrew M. Kowalevicz, Ashburn, VA (US); Gary M. Graceffo, Burke, VA (US)

(21) Appl. No.: 19/173,687

(22) Filed: Apr. 8, 2025

(51) Int. Cl. H04B 10/61; H04B 10/25

(52) U.S. Cl. CPC H04B 10/615; H04B 10/25

(57) ABSTRACT

A system includes an array of small-aperture optical receivers. The system also includes one or more optical resonators coupled to the array of small-aperture optical receivers. The system further includes an array of delay circuits coupled to the array of small-aperture optical receivers. In addition, the system includes an optical-electrical converter configured to receive an output of the one or more optical resonators.

### TECHNICAL FIELD

This disclosure relates generally to communication systems and processes. More specifically, this disclosure relates to a segmented receiver for phase-modulated signals.

### BACKGROUND

Transmissions (such as optical or radio frequency waveforms) used in traditional free-space communications experience various reflections, which may be due to physical structures or atmospheric variations and may result in weak phase-modulated signals being received. To be effective, conventional optical receivers that receive weak phase-modulated signals often use very large apertures, since larger apertures can capture larger amounts of free space light. Additionally, under many circumstances, the use of adaptive optics may be needed, such as systems that include deformable mirrors and wavefront sensors to correct for distortion in received light caused by atmospheric turbulence. Using the combination of large optical apertures and adaptive optics extremely expensive and hard to implement on light platforms.

### SUMMARY

This disclosure provides a segmented receiver for phase-modulated signals.

In some examples, a system includes an array of small-aperture optical receivers. The system also includes one or more optical resonators coupled to the array of small-aperture optical receivers. The system further includes an array of delay circuits coupled to the array of small-aperture optical receivers using a plurality of multimode fibers. In addition, the system includes an optical-electrical converter configured to receive an output of the one or more optical resonators.

Any single one or any combination of the following features may be used with the above examples. The array of delay circuits may be disposed between the one or more optical resonators and the optical-electrical converter. The array of small-aperture optical receivers may be configured to be loosely aligned to a source such that light received by the array of small-aperture optical receivers may be coupled into the plurality of multimode fibers. The array of delay circuits may be configured to receive intensity-modulated signals from the one or more optical resonators. The array of delay circuits may be configured to produce an optical delay with accuracy based on a baud rate of a received signal and configured to steer the system to a desired light source using time delay circuits or phase shifters. The array of delay circuits may be disposed between the array of small-aperture optical receivers and the one or more optical resonators. The one or more optical resonators may be configured to combine the plurality of delayed signals from the array of delay circuits and provide an intensity-modulated signal to the optical-electrical converter.

In other examples, a method includes receiving a plurality of optical signals using an array of small-aperture optical receivers. The method also includes converting the plurality of optical signals into intensity-modulated signals using one or more optical resonators coupled to the array of small-aperture optical receivers. The method further includes converting the intensity-modulated signals into electrical signals using an optical-electrical converter.

Any single one or any combination of the following features may be used with the above examples. The method may include, after converting the plurality of optical signals into the intensity-modulated signals using the one or more optical resonators but before converting the intensity-modulated signals into the electrical signals using the optical-electrical converter, delaying the plurality of optical signals using an array of delay circuits coupled to the array of small-aperture optical receivers. The method may include, before converting the intensity-modulated signals into the electrical signals using the optical-electrical converter, combining the intensity-modulated signals using the optical-electrical converter. Receiving the plurality of optical signals using the array of small-aperture optical receivers may include loosely aligning the array of small-aperture optical receivers to a source such that the plurality of optical signals is coupled into a plurality of multimode fibers. The method may include, before converting the plurality of optical signals into the intensity-modulated signals using the one or more optical resonators, delaying the plurality of optical signals using an array of delay circuits coupled to the array of small-aperture optical receivers to produce a plurality of delayed signals. The method may include, after delaying the plurality of optical signals using the array of delay circuits, combining the plurality of delayed signals using the one or more optical resonators. The one or more optical resonators may include a single etalon.

In still other examples, a system includes an array of small-aperture optical receivers. The system also includes one or more etalons coupled to the array of small-aperture optical receivers. The system further includes an array of delay circuits coupled to the array of small-aperture optical receivers using a plurality of multimode fibers. In addition, the system includes an optical-electrical converter configured to receive an output of the one or more etalons.

Any single one or any combination of the following features may be used with the above examples. The array of delay circuits may be disposed between the one or more etalons and the optical-electrical converter. The array of small-aperture optical receivers may be configured to be loosely aligned to a source such that light received by the array of small-aperture optical receivers may be coupled into the plurality of multimode fibers. The array of delay circuits may be configured to receive intensity-modulated signals from the one or more etalons. The array of delay circuits may be configured to produce an optical delay with accuracy based on a baud rate of a received signal and configured to steer the system to a desired light source using time delay circuits or phase shifters. The array of delay circuits may be disposed between the array of small-aperture optical receivers and the one or more etalons.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIGS. 1A-1C illustrate example segmented receiver systems for phase-modulated signals in accordance with this disclosure;

FIG. 2 illustrates an example optical resonator, including a graph of received signal phase and a graph of output intensity of the optical resonator, in accordance with this disclosure;

FIG. 3 illustrates an example method for receiving optical signals using a segmented receiver according to this disclosure; and

FIG. 4 illustrates an example device for receiving optical signals using a segmented receiver in accordance with this disclosure.

### DETAILED DESCRIPTION

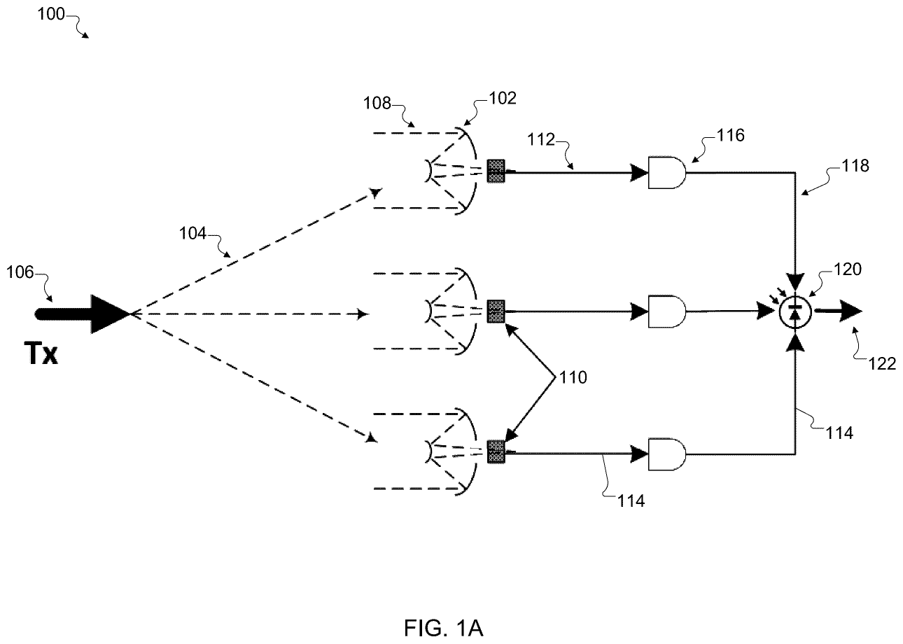

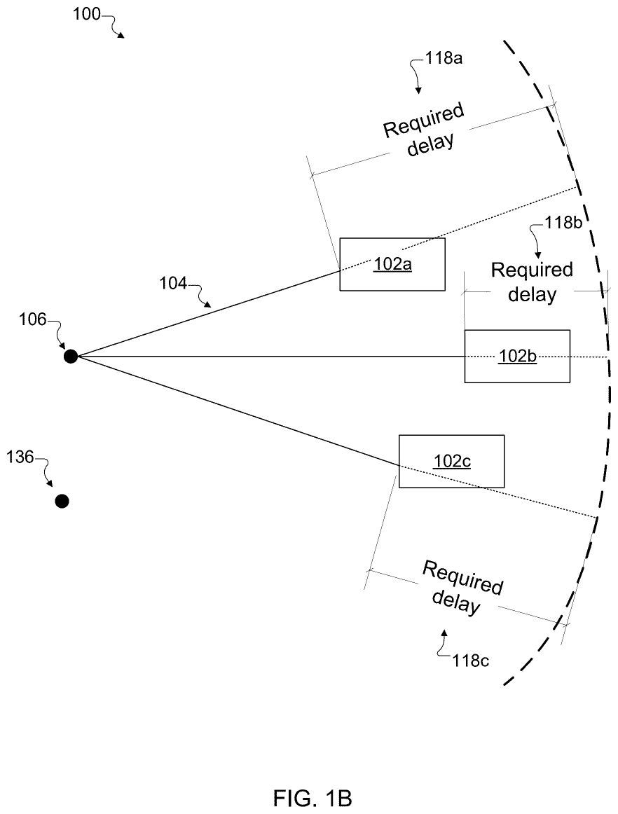

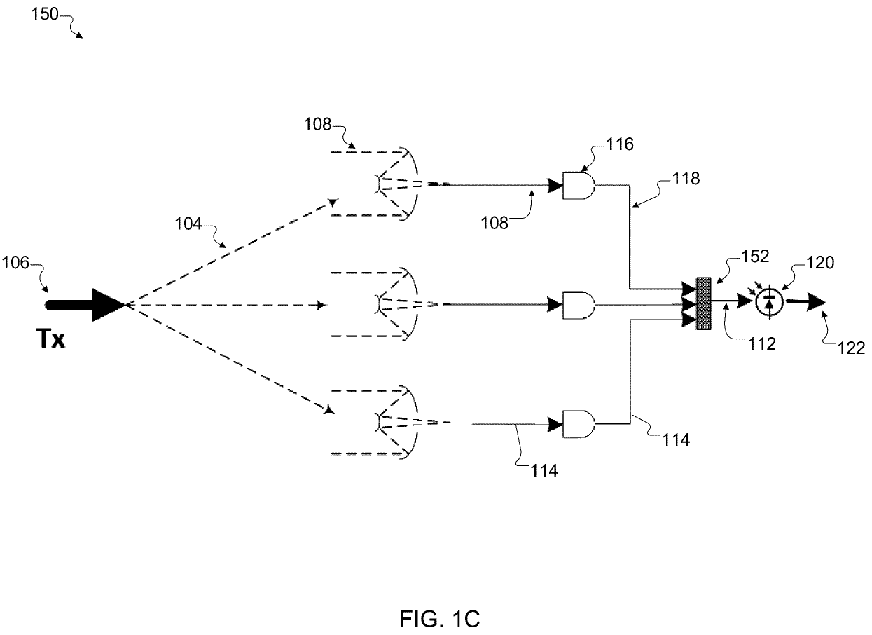

FIGS. 1A through 4, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

As noted above, transmissions (such as optical or radio frequency waveforms) used in traditional free-space communications experience various reflections, which may be due to physical structures or atmospheric variations and may result in weak phase-modulated signals being received. To be effective, conventional optical receivers that receive weak phase-modulated signals often use very large apertures, since larger apertures can capture larger amounts of free space light. Additionally, under many circumstances, the use of adaptive optics may be needed, such as systems that include deformable mirrors and wavefront sensors to correct for distortion in received light caused by atmospheric turbulence. Using the combination of large optical apertures and adaptive optics extremely expensive and hard to implement on light platforms.

This disclosure provides systems and methods for receiving optical signals using a segmented receiver. The segmented receiver includes array of small-aperture optical receivers that are coupled to one or more optical resonators, which turn phase-modulated signals into intensity-modulated signals prior to conversion into electrical signals (such as in an optical-electrical converter). The array of small-aperture optical receivers is coupled to the one or more optical resonators and the optical-electrical converter using a plurality of fibers. The plurality of fibers may be single mode fibers, multimode fibers, or a combination thereof. The multimode fibers allow for multiple optical signals to travel along shorter distances, reducing space and cost. The segmented receiver systems of this disclosure are capable of receiving and processing weak phase-modulated signals at a reduced size and cost without the use of adaptive optics in each aperture.

FIG. 1A-1C illustrate example segmented receiver systems 100, 150 for phase-modulated signals in accordance with this disclosure. In particular, FIG. 1A illustrates an example segmented receiver system 100 having multiple optical resonators, FIG. 1B illustrates the example segmented receiver system 100 having different delay values, and FIG. 1C illustrates an example segmented receiver system 150 having a single optical resonator.

As shown in FIG. 1A, the segmented optical receiver system 100 includes an array of small-aperture optical receivers 102 that receive light 104 from at least one light source 106. In some embodiments, the array of small-aperture optical receivers 102 includes optical receivers each having an aperture with a diameter of about 20 cm or less, such as about 10 cm or less, and may include an aperture with a diameter that is larger than the Fried parameter (r₀) of an incoming wavefront. In various embodiments, the array of small-aperture optical receivers 102 may function as light buckets.

The segmented optical receiver system 100 also includes one or more optical resonators 110 configured to receive and convert the phase-modulated signals 108 into intensity-modulated signals 112. The phrase “phase modulation” may include various complex or other modulation schemes including, but not limited to, binary phase-shift keying (BPSK), quadrature phase-shift keying (QPSK), quadrature amplitude modulation (QAM), and variations thereof. In some embodiments, the one or more optical resonators 110 may be coupled to outputs of the array of small-aperture optical receivers 102 (such as fitted directly onto the array of small-aperture optical receivers 102). The one or more optical resonators 110 are also coupled to an array of delay circuits 116 using a plurality of fibers 114. The array of small-aperture optical receivers 102 can be loosely aligned to the light source 106, where “loosely aligned” means alignment with the light source 106 sufficient to couple the light 104 into the plurality of fibers 114 (such as through the one or more optical resonators 110) for detection by the segmented optical receiver system 100. The use of the plurality of fibers 114 allows for different small-aperture optical receivers 102 to be separated from each other (possibly by large distances) with no optical correlation between respective focal planes of the small-aperture optical receivers 102.

To adjust for timing mismatches in the intensity-modulated signals 112 (such as from phase-modulated signals 108 received at different small-aperture optical receivers 102 of the segmented optical receiver system 100) that are received, the segmented optical receiver system 100 uses the array of delay circuits 116 to apply optical delays (such as by adding delay values) to the intensity-modulated signals 112 in order to produce a plurality of delayed signals 118. As shown in FIG. 1B, the accuracy of the optical delays may be based on a baud rate of the received signal at a respective small-aperture optical receiver 102. In other words, each optical receiver 102 (such as a first small-aperture optical receiver 102a, a second small-aperture optical receiver 102b, and a third small-aperture optical receiver 102c) may use a different optical delay to produce an accurate delay signal 118 (such as a first delay signal 118a, a second delay signal 118b, and a third delay signal 118c). The baud rate determines the accuracy of delay circuits 116, and the locations of each of the small-aperture optical receivers 102 determine the value of the delay. The delay corresponds to the difference of the locations of the array of small-aperture optical receivers 102 with respect to the light source 106. Note that if multiple delayed signals 118 are present, one, some, or all of the intensity-modulated signals 112 may be delayed to produce the delayed signals 118. Each delay value applied by the array of delay circuits 116 can be used to adjust the timing of the respective intensity-modulated signal 112, such as to align with one or more other intensity-modulated signals 112 of light 104 received at one or more other small-aperture optical receivers 102.

Further, the array of delay circuits 116 may steer the optical receiver system 100. For example, the array of delay circuits 116 may introduce varying time or phase delays, such as by using time delay circuits or phase shifters, so that radiation received from a desired direction (like from a desired light source 136) combines constructively in a portion of the array of small-aperture optical receivers 102. As such, the combined radiation pattern of the optical receiver system 100 may be steered (such as from facing a first light source 106 to facing a second light source 136) without physically steering the optical receiver system 100.

Referring to FIG. 1A, the delayed signals 118 that are produced are combined at an optical-electrical converter (OEC) 120, which uses the combined delayed signals 118 to produce electrical signals 122. Although the intensity-modulated signals 112 may be combined at the OEC 120 without added delay values, the plurality of delayed signals 118 allows for reduced destruction of the intensity-modulated signals 112 in the OEC 120, producing stronger and more accurate electrical signal(s) 122.

As shown in FIG. 1C, the segmented optical receiver system 150 is configured similarly to the segmented optical receiver system 100, except that the one or more optical resonators 110 are replaced by a single optical resonator 152 coupled between the array of delay circuits 116 and the OEC 120. The segmented optical receiver system 150 receives the light 104 and converts the light 104 into phase-modulated signals 108 using the array of small-aperture optical receivers 102. The array of small-aperture optical receivers 102 is loosely aligned to the light source 106 sufficient to couple the light 104 into the plurality of fibers 114 for detection by the segmented optical receiver system 150. The phase-modulated signals 108 travel through the plurality of fibers 114 into the array of delay circuits 116 to produce the plurality of delayed signals 118, which are combined using the single optical resonator 152. The single optical resonator 152 receives the delayed signals 118 and combines the delayed signals 118 to produce a single intensity-modulated signal 112 that is provided to the OEC 120.

Examples of optical resonators that may be used as the one or more optical resonators 110, 152 could include Fabry-Perot etalons, micro-rings, or other types of resonators. Each optical resonator 110, 152 represents a component capable of sensing transitions, such as phase variations, representative of modulation received at an optical receiver and transforming the transitions into intensity modulations of an output optical signal, such as the intensity-modulated signals 112. Each optical resonator 110, 152 can convert the modulation of an arriving phase-modulated signal 108 by interaction of the arriving phase-modulated signal 108 with resonant optical energy built-up in the optical resonator 110, 152.

As a particular example of this, an etalon is a component having semi-reflective surfaces that may include a transparent material in between and having one or more characteristic resonant frequencies, each associated with a certain wavelength of light, based upon the spacing (dimensional length) between the semi-reflective surfaces. The surfaces are semi-reflective and also semi-transmissive in that they allow some light through, so an arriving phase-modulated signal 108 may be allowed into the etalon and may resonate inside the etalon between the two semi-reflective surfaces. Additionally, some of the light resonating inside is allowed out of the etalon through the semi-transmissive surface. Light emerging from the etalon is shown, for example, as an intensity-modulated signal 112.

An optical signal received by an optical resonator 110, such as an etalon, may establish a steady-state energy-conserving condition in which optical signal energy continuously arrives at the optical resonator 110, accumulates or adds to built-up resonating energy existing inside the optical resonator 110, and emerges from the optical resonator 110 at a constant rate. A change in the arriving phase, frequency, or amplitude of the optical signal may disrupt the resonance inside the optical resonator 110, and the light intensity emerging from the optical resonator 110 is also disrupted until a steady state condition is re-established. Accordingly, a change in phase, frequency, or amplitude of the arriving phase-modulated signal 108 causes a change in intensity of the emerging intensity-modulated signal 112. A large phase transition in the arriving phase-modulated signal 108, for example, may cause a large (but temporary) intensity change in the emerging intensity-modulated signal 112. Similar operation can occur in a micro-ring or other optical resonator, and the optical resonator 110 can function as a demodulator or a modulation converter for the phase-modulated signal 108. The emerging intensity-modulated signal 112 may therefore carry the same information content as the arriving phase-modulated signal 108 but in intensity-modulated form.

The emerging intensity-modulated signals 112 may be converted to electrical signals by an optical-electrical converter, such as the OEC 120, which may include one or more photodetectors, such as photodiodes. Accordingly, the output of the OEC 120 may be amplitude-modulated electrical signals 122 representative of the intensity-modulated signals 112. The electrical signals 122 can be provided to a digital processing subsystem for digital processing, such as to process the electrical signals 122 to receive information-carrying content of the phase-modulated signals 108.

In various examples, the segmented optical receiver system 100 according to embodiments disclosed here may include additional or fewer optics than discussed above and may omit or add various components relative to those discussed above. For example, focusing optics may be included to receive the emerging intensity-modulated signals 112 from the one or more optical resonators 110 and to focus the intensity-modulated signals 112 on the OEC 120.

In various embodiments, any of the small-aperture optical receivers described here may be combined with elements of traditional optics systems. For example, an optical resonator, such as an etalon, may be placed near the focal point of an optical lens assembly, such as a telescope, and the delay values applied may beneficially correct for aberration in the light signal received. As a particular example, each of the small-aperture optical receivers 102 may include a telescope system coupled to one or more optical resonators 110. The telescope system may include one or more lenses, reflectors, etc. that gather an arriving light 104 from the light source 106.

In some embodiments, the telescope system may provide all or the majority of the selective directionality of the array of small-aperture optical receivers 102 because light signals coming from other directions may not enter an aperture of the telescope system or may not enter at a correct angle to couple to the one or more optical resonators 110 (FIG. 1A) or the plurality of fibers 114 (FIG. 1C). Accordingly, the telescope system may be positioned such that its axis is loosely aligned with the light source 106. Variations due to aberrations in the light 104, such as by atmospheric turbulence prior to the light 104 entering the telescope system, may result in differing arrival times at the one or more optical resonators 110 (FIG. 1A) or the plurality of fibers 114 (FIG. 1B). Accordingly, delay values applied to outputs from the array of small-aperture optical receivers 102 may be used to compensate for aberration effects as previously described. Thus, the array of small-aperture optical receivers 102 may accommodate and compensate for aberration without the use of adaptive optics or other conventional corrective techniques. This allows for the optical signals received from different apertures of the small-aperture optical receivers 102 to be delayed with respect to each other and combined by a single OEC 120.

Any of the processing previously described, such as obtaining signals, applying one or more delays to any signals, combining signals, demodulating signals, and control functions may be implemented in various forms of logic, whether in hardware or in a combination of hardware and software/firmware. The electrical signals 122 may be processed in analog form or may be converted to digital form, such as via analog-to-digital converters, and processed in digital form.

As described above, in some applications, it may be beneficial to apply delay values to the received phase-modulated signals 108 from the light 104 to compensate for aberration effects. Thus, the segmented optical receiver system 100 and the segmented optical receiver system 150 each includes the array of delay circuits 116 for delaying the intensity-modulated signals 112 (FIG. 1A) or the phase-modulated signals 108 (FIG. 1C).

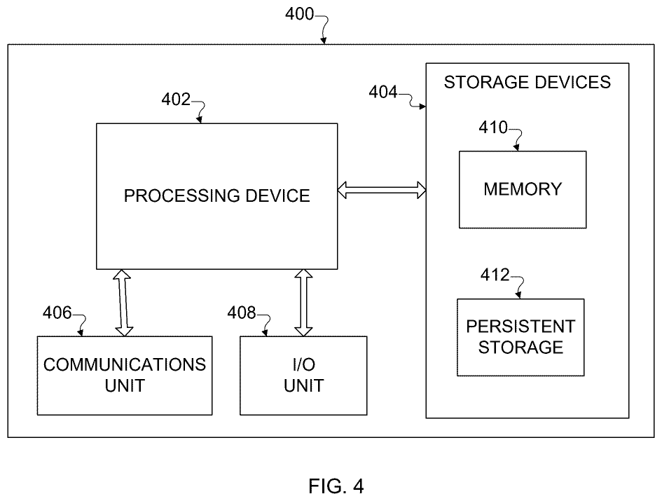

The array of delay circuits 116 may be controlled or selected by a controller (see FIG. 4) via one or more communication links. In some embodiments, a user selects the delay values for the array of delay circuits 116. Thus, this delay is a parameter of the segmented optical receiver systems 100, 150. The array of delay circuits 116 may be an optical delay circuit, such as an optical cavity or adjustable fiber length. Optical cavities, for example, allow for an increase in the distance traveled by optical signals or the path length of the optical signals (such as the phase-modulated signals 108, the intensity-modulated signals 112) by effectively employing a series of mirrors to iteratively reflect the optical signals. Each reflection induced thereby creates an additional length that the optical signal travels.

Although FIGS. 1A-1C illustrate examples of segmented optical receiver systems for phase-modulated signals, various changes may be made to FIGS. 1A-1C. For example, various components in FIGS. 1A-1C may be combined, further subdivided, replicated, omitted, or rearranged and additional components may be added according to particular needs.

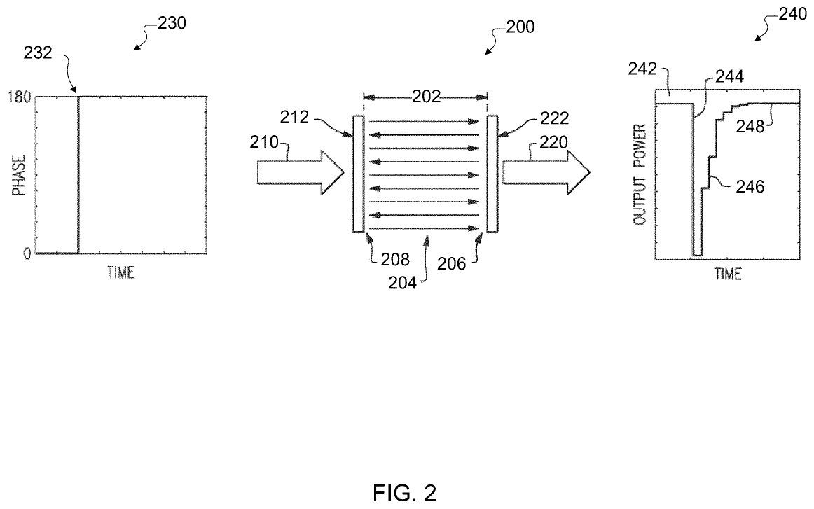

FIG. 2 illustrates an example an optical resonator 200, including a graph of received signal phase 230 and a graph of output intensity 260 of the optical resonator 200, in accordance with this disclosure. As discussed above, suitable optical resonators include etalons. At least one example of an etalon is discussed with respect to FIG. 2, which illustrates an example of an optical resonator 200 that may be used in various examples of a receiver in accordance with aspects and embodiments described here, such as in the one or more optical resonators 110, 152 in FIGS. 1A-1C.

A receiver may use the optical resonator 200 to convert phase modulations of a received phase-modulated input optical signal 210 into intensity or amplitude modulations of an intensity-modulated output signal 220. The intensity-modulated output signal 220 may be converted into an electrical signal with corresponding amplitude variations representative of the phase modulations of the received phase-modulated input optical signal 210. The optical resonator 200 causes the received phase-modulated input optical signal 210 to resonantly interact with itself, internal to the optical resonator 200, such that phase changes in the received phase-modulated input optical signal 210 disrupt the resonance and cause amplitude (or intensity) variations at the intensity-modulated output signal 220, which may be coupled directly to a detector.

In some embodiments, the optical resonator 200 is designed to have a resonant frequency aligned with a source of the received phase-modulated input optical signal 210, such as a transmit laser. In various examples, a dimensional scale, such as length 202, of the optical resonator 200 is selected such that the optical resonator 200 exhibits optical resonance at the wavelength of the received phase-modulated input optical signal 210. Also, in various examples, such dimensional scales may be much shorter than the length of a transmitted symbol, which is the distance traveled by the optical signal between transitions that convey information, such as between phase changes in a phase-modulated signal.

The optical resonator 200 includes an interior 204 with semi-reflective surfaces 206, 208 that reflect optical signal energy into the interior 204. An input side 212 allows optical signal energy, such as the phase-modulated input optical signal 210, into the interior 204. The input side 212 thereby forms an aperture through which the arriving phase-modulated input optical signal 210 is received. An output side 222 forms an optical output, which can be defined at least in part by action of the semi-reflective surface 206, to allow a portion of trapped optical signal energy from the interior 204 to emerge as an output optical signal, such as the intensity-modulated output signal 220. Accordingly, the semi-reflective surface 206 is also semi-transmissive such that optical signal energy arriving (from the interior 204) at the semi-reflective surface 206 is partially reflected back to the interior 204 and partially transmitted through to the output side 222.

The optical resonator 200 may have varying levels of reflectivity of the semi-reflective surfaces 206, 208. In some examples, the reflectivity may be expressed as a fraction of light amplitude reflected back into the interior 204 or may be expressed as a fraction of light intensity reflected back into the interior 204. For example, an amplitude reflectivity of the first semi-reflective surface 208 may be r₁=0.999, and an amplitude reflectivity of the second semi-reflective surface 206 may be r₂=0.985. Alternatively, the amplitude reflectivities may be between R=r²=30% and 90%. In other examples, the reflectivity of each of the first and second semi-reflective surfaces may be different and may be any suitable value for a particular implementation. The optical resonator 200 is one example of a suitable optical resonator in accordance with aspects and embodiments described here.

In some embodiments, the optical resonator 200 can coherently develop an output signal based on the input signal and maintain a given level of the output signal until a modulation in the phase of the input signal occurs. When a phase modulation occurs in the input signal, destructive interference causes a phase-dependent change in the amplitude of the output signal. This can be seen in the graphs of the received signal phase 230 and the output power plot 240 illustrated in FIG. 2. Accordingly, a received phase-encoded optical communication signal, such as the phase-modulated input optical signal 210, is converted into an amplitude-varying signal, such as the intensity-modulated output signal 220, by the optical resonator 200. The intensity-modulated output signal 220 is suitable for direct detection by a sensor, such as the OEC 120 of FIGS. 1A-1C.

Additionally, the optical resonator 200 can function over a broad range of data rates without the need to modify the optical characteristics of the system, such as detector setup, path length adjustments, delay elements, or the like. For example, the ability of the optical resonator 200 to convert an arriving phase-modulated input optical signal 210 into an intensity-modulated output signal 220 may be independent of the modulation rate at which the input phase is changing in some examples.

The use of the term “etalon” throughout this disclosure is not intended to be limiting and as used here may include any of multiple types of structures, including plates with reflecting surfaces as well as parallel mirrors with various materials in between, and may also be referred to as cavities, interferometers, and the like. Additionally, etalon structures may be formed as a laminate, layer, film, coating, or the like.

FIG. 2 further illustrates operation of the optical resonator 200 with reference to the output power plot 240 of optical signal intensity (as output power) emerging from the optical resonator 200 during a phase transition 232 in the received phase-modulated input optical signal 210. At point 242, the optical resonator 200 is in a steady-state resonance condition, where a steady intensity of light emerges. At point 244, a phase transition 232 occurs in the arriving phase-modulated input optical signal 210, temporarily disrupting the steady-state and causing a change in the emerging light intensity. During successive reflections inside the etalon at point 246, resonance is being re-established, and the emerging light intensity increases until a steady intensity of light emerges at point 248 when the optical resonator 200 has returned to a steady-state condition.

Accordingly, variations in emerging light intensity from the optical resonator 200 indicate that transitions occurred in an arriving optical signal, such as a phase, frequency, or amplitude variations, and such may be used by appropriate signal processing to determine useful information by analyzing the emerging light intensity. In the example discussed above and illustrated in FIG. 2, the arriving phase-modulated input optical signal 210 is presumed to be phase-modulated, but other examples include frequency or amplitude modulation or any combination of these, which may cause similar variations or other detectable variations in output intensity. In some examples, higher-order or more complex modulation may be accommodated by various optical resonator designs.

As a particular example, an etalon tuned to the arriving wavelength reacts to a phase variation in the arriving optical signal in accordance with the discussion above and as illustrated in FIG. 2. If the arriving optical signal is modulated with binary phase shift keying (BPSK), for example, the output illustrated in FIG. 2 indicates each phase shift, and the information carried in the phase shift keying may be recovered from the intensity variations at the intensity-modulated output signal 220. It should be understood by those of skill in the art with the benefit of this disclosure that such information recovery is achieved without the necessity for a local coherent clock source or the need to support single-mode coupling, such as to a single-mode fiber and delay-line interferometer, to demodulate the arriving optical signal.

In some examples, an etalon may include reflective surfaces (including semi-reflective surfaces) that are not co-planar and/or are not co-linear. For example, an interior reflective surface of an etalon may include some curvature, and an opposing surface may also be curved such that a distance between the two surfaces may be substantially constant across various regions of the etalon. In other cases, an etalon may have non-linear or non-planar surfaces with varying distances between the surfaces at various regions and may still function as an optical resonator for various wavelengths and at various regions suitable for use in the examples discussed here. Accordingly, an etalon may be purposefully designed to conform to a surface or to have various regions responsive to differing wavelengths or responsive to differing angles of arrival for a given wavelength.

Although FIG. 2 illustrates one example of an optical resonator 200 and example graphs of received signal phase 230 and output intensity 260 of the optical resonator 200, various changes may be made to FIG. 2. For example, various components in FIG. 2 may be combined, further subdivided, replicated, omitted, or rearranged and additional components may be added according to particular needs. Also, the specific graphs are examples only, and the optical resonator 200 is not limited to these specific characteristics.

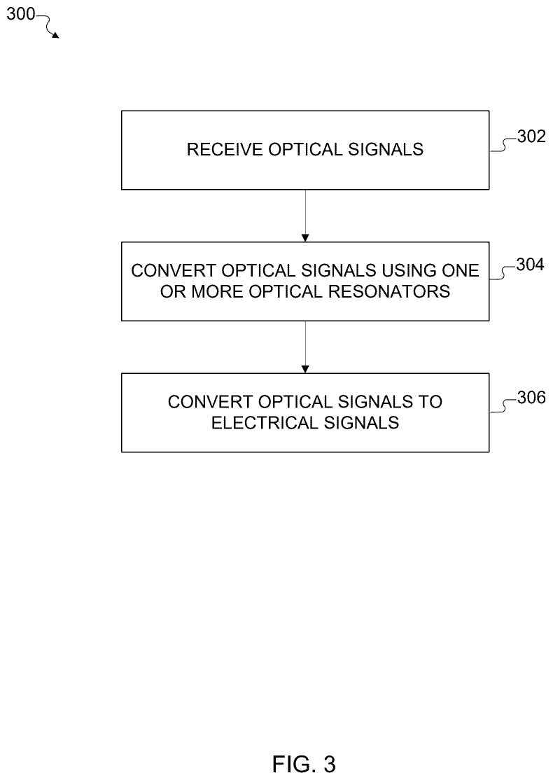

FIG. 3 illustrates an example method 300 for receiving optical signals using a segmented receiver according to this disclosure. For ease of explanation, the method 300 of FIG. 3 is described as being performed using the segmented optical receiver system 100 of FIG. 1A or the segmented optical receiver system 150 of FIG. 1C. However, the method 300 may be used with any other suitable system and any other suitable segmented optical receiver system.

As shown in FIG. 3, a plurality of optical signals (such as phase-modulated signals 108) is received using the array of small-aperture optical receivers 102 at step 302. For example, the array of small-aperture optical receivers 102 may receive light 104 and convert the light 104 into the phase-modulated signals 108. The array of small-aperture optical receivers 102 may be loosely aligned to the light source 106 such that the phase-modulated signals 108 are coupled into the plurality of fibers 114 (such as through the one or more optical resonators 110 in the segmented optical receiver system 100 of FIG. 1A or directly into the plurality of fibers 114 in segmented optical receiver system 150 of FIG. 1C).

The phase-modulated signals 108 are converted into intensity-modulated signals using one or more optical resonators 110 coupled, by plurality of fibers 114, to the array of small-aperture optical receivers 102 at step 304. For example, the array of small-aperture optical receivers 102 may be fitted with the one or more optical resonators 110. In such embodiments, the phase-modulated signals 108 from the array of small-aperture optical receivers 102 are fed into the one or more optical resonators 110 for conversion into the intensity-modulated signals 112 as described above. After converting the phase-modulated signals 108 into the intensity-modulated signals 112 using the one or more optical resonators 110, the phase-modulated signals 108 may be delayed (such as by adding a delay value) using the array of delay circuits 116 coupled to the array of small-aperture optical receivers 102, producing a plurality of delayed signals 118.

Alternatively, before converting the phase-modulated signals 108 into the intensity-modulated signals using the one or more optical resonators 110, the phase-modulated signals 108 may be delayed using the array of delay circuits 116 coupled to the array of small-aperture optical receivers 102 to produce a plurality of delayed signals 118 as shown in the segmented optical receiver system 150 of FIG. 1C. After delaying the phase-modulated signals 108 using the array of delay circuits 116, the plurality of delayed signals may be combined using the single optical resonator 152, where the single optical resonator 152 may be a single etalon.

The intensity-modulated signals 112 are converted into electrical signals 122 using an OEC 120 at step 306. For example, the plurality of delayed signals 118 from the array of delay circuits 116 in the segmented optical receiver system 100 may be provided into the OEC 120 using the plurality of fibers 114. Additionally, before converting the intensity-modulated signals 112 into the electrical signals 122 using the OEC 120, the plurality of delayed signals 118 may be combined using the OEC 120. The OEC 120 converts the plurality of delayed signals 118 of the segmented optical receiver system 100 or the intensity-modulated signals 112 of the segmented optical receiver system 150 into the electrical signals 122.

Although FIG. 3 illustrates one example of a method 300 for receiving optical signals using a segmented receiver, various changes may be made to FIG. 3. For example, while shown as a series of steps, various steps in FIG. 3 may overlap, occur in parallel, or occur any number of times.

FIG. 4 illustrates an example device 400 for receiving optical signals using a segmented receiver according to this disclosure. One or more instances of the device 400 (or portions thereof) may, for example, be used to at least partially implement the functionality of the segmented optical receiver systems 100, 150 of FIGS. 1A and 1C. However, the functionality of the segmented optical receiver systems 100, 150 may be implemented in any other suitable manner.

As shown in FIG. 4, the device 400 denotes a computing device or system that includes at least one processing device 402, at least one storage device 404, at least one communications unit 406, and at least one input/output (I/O) unit 408. The processing device 402 may execute instructions that can be loaded into a memory 410. The processing device 402 includes any suitable number(s) and type(s) of processors or other devices in any suitable arrangement. Example types of processing devices 402 include one or more microprocessors, microcontrollers, digital signal processors (DSPs), application-specific integrated circuits (ASICs), graphics processing units (GPUs), field-programmable gate arrays (FPGAs), or discrete circuitry.

The memory 410 and a persistent storage 412 are examples of storage devices 404, which represent any structure(s) capable of storing and facilitating retrieval of information (such as data, program code, and/or other suitable information on a temporary or permanent basis). The memory 410 may represent a random access memory or any other suitable volatile or non-volatile storage device(s). The persistent storage 412 may contain one or more components or devices supporting longer-term storage of data, such as a read only memory, hard drive, Flash memory, or optical disc.

The communications unit 406 supports communications with other systems or devices. For example, the communications unit 406 can include a network interface card or a wireless transceiver facilitating communications over a wired or wireless network. The communications unit 406 may support communications through any suitable physical or wireless communication link(s).

The I/O unit 408 allows for input and output of data. For example, the I/O unit 408 may provide a connection for user input through a keyboard, mouse, keypad, touchscreen, or other suitable input device. The I/O unit 408 may also send output to a display or other suitable output device. Note, however, that the I/O unit 408 may be omitted if the device 400 does not require local I/O, such as when the device 400 can be accessed remotely or operated autonomously.

In some embodiments, the instructions executed by the processing device 402 can include instructions that implement portions of the functionality of the segmented optical receiver system 100, 150 described above. For example, the instructions executed by the processing device 402 can include instructions for controlling one or more components of the segmented optical receiver system 100, 150, such as the array of delay circuits 116. Also, or alternatively, the instructions executed by the processing device 402 can include instructions for processing the electrical signals 122 or digitized versions thereof. Also, or alternatively, the instructions executed by the processing device 402 can include instructions for aligning the array of small-aperture optical receivers 102 (such as to a light source 106). Also, or alternatively, the instructions executed by the processing device 402 can include instructions for adjusting the one or more optical resonators 110 (such as adjusting the reflective surfaces of the one or more optical resonators 110 based on the received phase modulated signals 108).

Although FIG. 4 illustrates one example of a device 400 for receiving phase-modulated signals using a segmented receiver, various changes may be made to FIG. 4. For example, computing devices and systems come in a wide variety of configurations, and FIG. 4 does not limit this disclosure to any particular computing device or system.

In some embodiments, various functions described in this patent document are implemented or supported by a computer program or other program that is formed from computer readable program code or instructions and that is embodied in a computer or machine readable medium. The phrases “computer readable program code” and “instructions” include any type of code, including source code, object code, and executable code. The phrases “computer readable medium” and “machine readable medium” include any type of medium capable of being accessed by a computer or other machine, such as read only memory (ROM), random access memory (RAM), a hard disk drive (HDD), a compact disc (CD), a digital video disc (DVD), or any other type of memory. A “non-transitory” computer or machine readable medium excludes wired, wireless, optical, or other communication links that transport transitory electrical or other signals. A non-transitory computer or machine readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
an array of small-aperture optical receivers;
one or more optical resonators coupled to the array of small-aperture optical receivers;
an array of delay circuits coupled to the array of small-aperture optical receivers using a plurality of fibers; and
an optical-electrical converter configured to receive an output of the one or more optical resonators.

2. The system of claim 1, wherein the array of delay circuits is disposed between the one or more optical resonators and the optical-electrical converter, and wherein the plurality of fibers includes single mode fibers and/or multimode fibers.

3. The system of claim 1, wherein the array of small-aperture optical receivers is configured to be loosely aligned to a source such that light received by the array of small-aperture optical receivers are coupled into the plurality of fibers.

4. The system of claim 1, wherein the array of delay circuits is configured to receive intensity-modulated signals from the one or more optical resonators.

5. The system of claim 1, wherein the array of delay circuits is configured to produce an optical delay with accuracy based on a baud rate of a received signal and configured to steer the system to a desired light source using time delay circuits or phase shifters.

6. The system of claim 1, wherein the array of delay circuits is disposed between the array of small-aperture optical receivers and the one or more optical resonators.

7. The system of claim 6, wherein the one or more optical resonators are configured to combine the plurality of delayed signals from the array of delay circuits and provide an intensity-modulated signal to the optical-electrical converter.

8. A method comprising:
receiving a plurality of optical signals using an array of small-aperture optical receivers;
converting the plurality of optical signals into intensity-modulated signals using one or more optical resonators coupled to the array of small-aperture optical receivers; and
converting the intensity-modulated signals into electrical signals using an optical-electrical converter.

9. The method of claim 8, further comprising:
after converting the plurality of optical signals into the intensity-modulated signals using the one or more optical resonators but before converting the intensity-modulated signals into the electrical signals using the optical-electrical converter, delaying the plurality of optical signals using an array of delay circuits coupled to the array of small-aperture optical receivers.

10. The method of claim 9, further comprising:
before converting the intensity-modulated signals into the electrical signals using the optical-electrical converter, combining the intensity-modulated signals using the optical-electrical converter.

11. The method of claim 8, wherein receiving the plurality of optical signals using the array of small-aperture optical receivers comprises loosely aligning the array of small-aperture optical receivers to a source such that the plurality of optical signals is coupled into plurality of fibers.

12. The method of claim 8, further comprising:
before converting the plurality of optical signals into the intensity-modulated signals using the one or more optical resonators, delaying the plurality of optical signals using array of delay circuits coupled to the array of small-aperture optical receivers to produce a plurality of delayed signals.

13. The method of claim 12, further comprising:
after delaying the plurality of optical signals using the array of delay circuits, combining the plurality of delayed signals using the one or more optical resonators.

14. The method of claim 13, wherein the one or more optical resonators comprise a single etalon.

15. A system comprising:
an array of small-aperture optical receivers;
one or more etalons coupled to the array of small-aperture optical receivers;
an array of delay circuits coupled to the array of small-aperture optical receivers using a plurality of fibers; and
an optical-electrical converter configured to receive an output of the one or more etalons.

16. The system of claim 15, wherein the array of delay circuits is disposed between the one or more etalons and the optical-electrical converter.

17. The system of claim 15, wherein the array of small-aperture optical receivers is configured to be loosely aligned to a source such that light received by the array of small-aperture optical receivers are coupled into the plurality of fibers.

18. The system of claim 15, wherein the array of delay circuits is configured to receive intensity-modulated signals from the one or more etalons.

19. The system of claim 15, wherein the array of delay circuits is configured to produce an optical delay with accuracy based on a baud rate of a received signal and configured to steer the system to a desired light source using time delay circuits or phase shifters.

20. The system of claim 15, wherein the array of delay circuits is disposed between the array of small-aperture optical receivers and the one or more etalons.
